(19) United States
(12) Patent Application Publication
(10) Pub. No.: US 2005/0157274 A1
(43) Pub. Date: Jul. 21, 2005

(54) Color projection system

(76) Inventor: Kun-yueh Lin, Taoyuan County (TW)

Correspondence Address: BIRCH STEWART KOLASCH & BIRCH, PO BOX 747, FALLS CHURCH, VA, 22040-0747, US

(21) Appl. No.: 10/983,715

(22) Filed: Nov. 9, 2004

(30) Foreign Application Priority Data
Jan. 15, 2004 (TW) 93101006

(51) Int. Cl. G03B 21/26

(52) U.S. Cl. 353/84

(57) ABSTRACT

A color projection system includes a light source, a polarization conversion device, a color wheel, a color separation device, and two liquid crystal light valves. The color wheel is segmented to form at least a yellow section and a magenta section, which are alternately positioned in the traveling path of the light beam. The color separation device includes a dichroic element and two color selectors. The dichroic element has a light input side, a first split-light side, a second split-light side, and a light output side, and the light beam enters the dichroic element by the light input side and leaves the dichroic element by the light output side toward a projection lens. The first and second color selectors are disposed adjacent to the light input side and the light output side of the dichroic element, respectively.

### BACKGROUND OF THE INVENTION

a) Field of the Invention

The invention relates to a color projection system and, more particularly, to a color projection system using two liquid crystal light valves.

b) Description of Related Art

Conventional color projection systems are designed to have three liquid crystal light valves or spatial light modulators to respectively correspond to the primary colors: red (R), green (G), and blue (B). In order to lower the manufacturing cost and simplify the optical arrangement of a projection display, an improved design that needs only one liquid crystal light valve by means of timesharing control for alternating the three primary colors represented in a color wheel has been developed. Though such design may effectively lower the manufacturing cost, the liquid crystal light valve is required to operate at a high frequency of at least 180 Hz for sequentially switching among the three primary colors. This may result in color breakup on the edges of a displayed moving object; additionally, as such design is incorporated in a color projection system, its brightness may considerable decreased since only ⅓ of the incoming light can be utilized at a time.

Therefore, in an attempt to reach a compromise, a projection display design using two liquid crystal light valves or spatial light modulators are developed. Referring to FIG. 5, two light valves 104 and 106 are placed on two adjacent faces of a polarizing beam splitter cube 108. White light illumination from a source is introduced through a third face of the polarizing beam splitter cube 108, and a projection lens 110 images the light valves through a fourth face of the cube. The three primary colors, red (R), green (G) and blue (B), are introduced through a color wheel 102 one at a time for this system, and the illumination is alternated from one light valve to the other. Alternating between the two light valves 104 and 106 is accomplished by alternating the polarization state of the incoming illumination source. Thereby, the reflective liquid crystal light valves 104 and 106 can operate at a lower frequency of 90 Hz and gain sufficient responding time to lower the dead-time effect in a single light valve design. However, this design still utilizes only ⅓ of the white light illumination.

FIG. 6 shows another projection system design using two light valves. Referring to FIG. 6, the color selectors 124 and 126 are used to change the polarization state of only the red light. When incoming white light I enters a polarization beam splitter cube 122, the red light illuminates the liquid crystal light valve 128 after reflecting off the polarization beam splitter cube 122 and then enters a projection lens 134. On the other hand, the blue and green light directly pass through the polarization beam splitter cube 122. In this design, a color switch 132 is disposed between the polarization beam splitter cube 122 and a liquid crystal light valve 130 to allow sequential passing of the blue and green lights. Though this design may enhance the utilization efficiency of the incoming white light I, the color switch 132 is very sensitive to temperature variation, and thus the color projection system incorporating the color switch 132 is severely limited in the received light flux from a light source.

### SUMMARY OF THE INVENTION

Therefore, an object of the invention is to provide a color projection system that is able to solve the aforesaid problems existing in conventional designs of using two light valves.

According to the invention, a color projection system includes a light source for generating a light beam comprised of a first, second and third colored lights, a polarization conversion device for polarizing the light beam, a color wheel, a color separation device, and two liquid crystal light valves. The color wheel is segmented to form at least a first section for filtering out the second colored light and a second section for filtering out the third colored light. The first and second sections are alternately positioned in the traveling path of the light beam. The color separation device includes a dichroic element and two color selectors. The dichroic element has a light input side, a first split-light side, a second split-light side, and a light output side, and the light beam enters the dichroic element by the light input side and leaves the dichroic element by the light output side toward a projection lens. The first and second color selectors are disposed adjacent to the light input side and the light output side of the dichroic element, respectively.

When the color wheel filters out the second colored light, the third colored light illuminates the first liquid crystal light valve via the first split-light side of the dichroic element and the first colored light illuminates the second liquid crystal light valve via the second split-light side; when the color wheel filters out the third colored light, the second colored light illuminates the first liquid crystal light valve via the first split-light side of the dichroic element and the first colored light illuminates the second liquid crystal light valve via the second split-light side.

Through the design of the invention, since the color switch component is no longer required, the projection system can tolerate higher light flux to enhance the display brightness. Also, the color wheel will not be affected by temperature variation.

Further, no matter what sections on the color wheel the light beam may pass through, the passed light beam will contain the red light to automatically compensate the weaker red light output of the ultra high pressure mercury lamp. Thus, according to the invention, better visual brightness is achieved without the need of correcting the white balance.

### BRIEF DESCRIPTION OF THE DRAWINGS

FIG. 1 shows a schematic diagram illustrating an embodiment of a color projection system according to the invention.

FIG. 2 shows schematic diagrams illustrating different distributions of colored sections over a color wheel according to the invention.

FIG. 3A shows a schematic diagram illustrating the light path for the light passing through the yellow section of the color wheel.

FIG. 3B shows a schematic diagram illustrating the light path for the light passing through the magenta section of the color wheel.

FIG. 4 shows a schematic diagram illustrating another embodiment of the color projection system according to the invention.

FIG. 5 shows a schematic diagram illustrating a color projection device disclosed in U.S. Pat. No. 5,517,340.

FIG. 6 is a schematic diagram illustrating a color projection device disclosed in U.S. Pat. No. 6,545,804.

### DETAIL DESCRIPTION OF THE INVENTION

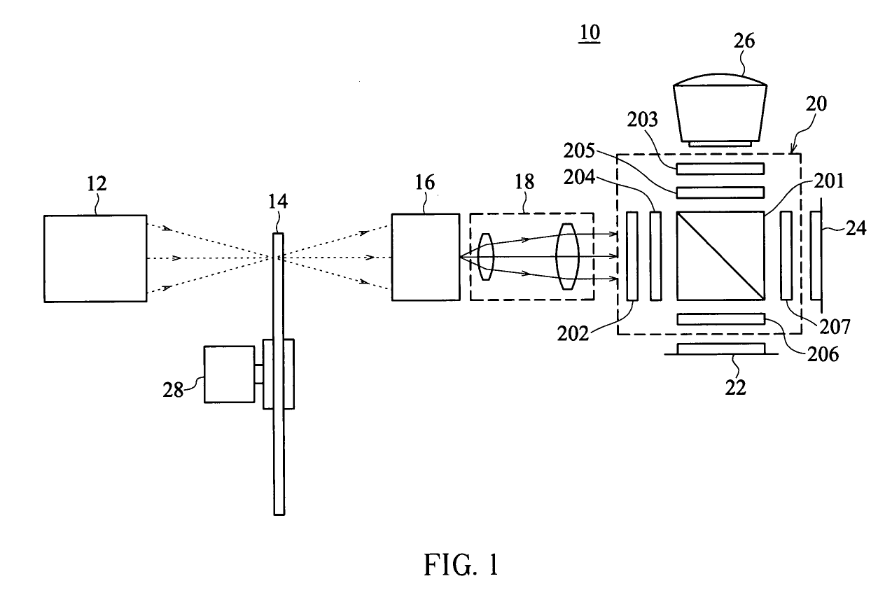

Referring to FIG. 1, a color projection system 10 includes a light source 12, a color wheel 14, a polarization conversion device 16, an illumination optics 18, a color separation device 20, a first and a second liquid crystal light valves 22 and 24, and a projection lens 26. The color separation device 20 includes a dichroic element such as a polarized beam splitter cube 201, a first and a second polarizers 202, 203, a first and a second color selectors 204 and 205, and a first and a second quarter wave plates 206 and 207. All optical components constituting the color separation device 20 are arranged like a cross where the polarized beam splitter cube 201 is at its center. Part optical components arranged from the bottom to the top are the first liquid crystal light valve 22, the first quarter wave plate 206, a first split-light side of the polarized beam splitter cube 201, a light output side of the polarized beam splitter cube 201, the second color selector 205 and the second polarizer 203; part optical components arranged from the left to the right are the first polarizer 202, the first color selector 204, a light input side of the polarized beam splitter cube 201, a second split-light side of the polarized beam splitter cube 201 and the second quarter wave plate 207. The liquid crystal light valve may be a reflective liquid crystal on silicon (LCOS) panel.

The color wheel 14 rotates by means of a driving device such as a motor 28. As is known in the art, the color wheel 14 may be segmented such that different portions of the color wheel 14 will transmit different colored lights. According to this embodiment, the color wheel 14 is segmented to create equal size sections, where a first section reflects only the blue light and the second section reflects only the green light. Hereinafter, the first section is referred to as a “yellow section (Y)” and the second section is referred to as a “magenta section” (M). The yellow section (Y) is made of a filter plate that reflects only the blue light and transmits the remainder, and the magenta section (M) is made of a filter plate that reflects only the green light.

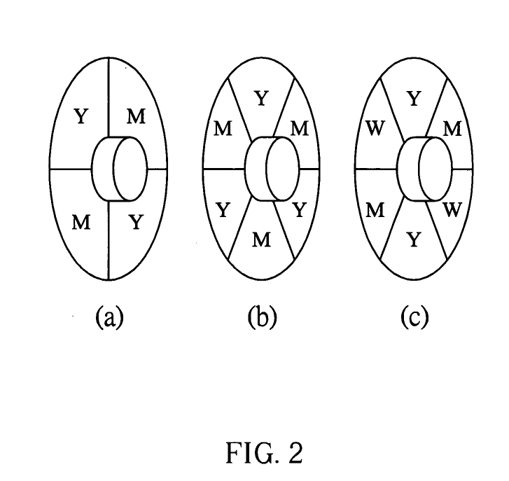

The distribution of the yellow section (Y) and the magenta section (M) over the color wheel is not limited. For example, the yellow section (Y) and the magenta section (M) may alternately occupy four equal size sections of the color wheel, as in FIG. 2(a), or six equal size sections, as in FIG. 2(b). Alternatively, a white light transmitting section (W) may be added to enhance the brightness, as shown in FIG. 2(c).

Referring back to FIG. 1, the polarization conversion device 16 is used to polarize the light from the light source 12 to make the light have a specific polarization state such as S-polarization state. Then, the light beam having S-polarization state is received in the color separation device 20. The illumination optics 18 such as a lens assembly is used to form illumination areas on the liquid crystal light valves 22 and 24. Since the color wheel 14 is disposed in the traveling path of the light beam from the light source 12, when the color wheel 14 rotates, the yellow and magenta sections are alternately positioned in the light path to respectively filter out the blue and the green light. Subsequently, the remaining light is polarized by the polarization conversion device 16 and passes through the illumination optics 18 before entering the color separation device 20.

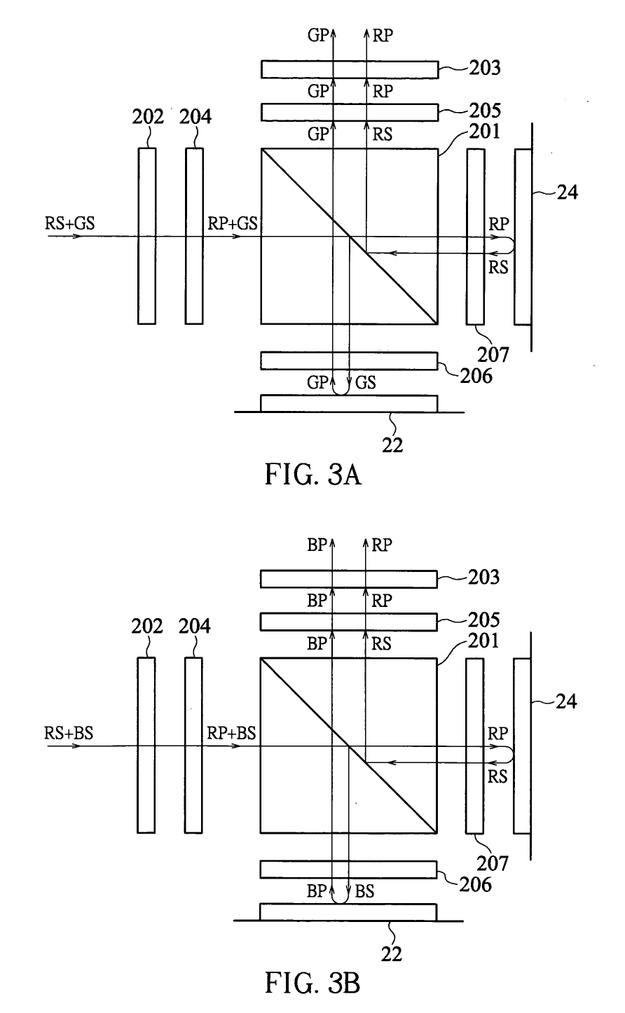

Referring to FIG. 3A, when the incoming light radiates the yellow section (Y), the blue light will be reflected while the red and green lights will pass the yellow section (Y) and be polarized to have a specific polarization state such as S-polarization state by the polarization conversion device 16. Then, the red light with S-polarization state (RS) and the green light with S-polarized light (GS) both encounter the polarizer 202 and the color selector 204 sequentially.

According to this embodiment, the color selector 204, manufactured by Colorlink company, is a Red/Cyan color selector that changes the polarization state of only the red light. Thus, the yellow light with S-polarization state (RS+GS) are transformed into a combination of a red light with P-polarization state (RP) and a green light with S-polarization state (GS) as passing the color selector 204. Since the coating of the polarized beam splitter cube 201 is designed to reflect S-polarization light and to allow P-polarization light to pass through, the red light with P-polarization (RP) directly passes through the polarized beam splitter cube 201 and then illuminate the liquid crystal light valve 24. At the same time, the polarized beam splitter cube 201 reflects the green light with S-polarization state (GS) to make it illuminate the liquid crystal light valve 22.

When the liquid crystal light valve is in “On state”, it reflects the incoming light beam and meanwhile changes its polarization state. Thus, the red light with P-polarization state (RP) reflected by the liquid crystal light valve 24 is transformed into the red light with S-polarization state (RS), which is further reflected by the polarized beam splitter cube 201 and passes the color selector 205. The color selector 205 changes the polarization state of the red light again, and finally the red light with P-polarization state (RP) passes the second polarizer 203 before entering the projection lens 26. On the other hand, the green light with S-polarization state (GS) reflected by the liquid crystal light valve 22 is transformed into the green light with P-polarization state (GP), which further sequentially pass through the polarized beam splitter cube 201 and the color selector 205. The color selector 205 does not change the polarization state of the green light, and finally the green light with P-polarization state (GP) passes the second polarizer 203 before entering the projection lens 26.

Referring to FIG. 3B, when the incoming light radiates the magenta section (M), the green light will be reflected while the red and blue light will pass the magenta section (M) and be polarized to have a specific polarization state such as S-polarization state by the polarization conversion device 16. The traveling paths of the red light with S-polarization state (RS) and the blue light with S-polarization state (BS) in the color separation device 20 are the same as that shown in FIG. 3A, except the green light (G) is replaced with the blue light (B), thus not explained in detail.

According to the invention, the first and the second polarizers 202 and 203 are disposed to purify the polarization of the incoming colored light. Further, the first and second quarter wave plates 206 and 207 are disposed between the polarized beam splitting cube 201 and the liquid crystal light valves 22 and 24, respectively, for improving the contrast ratio of the projection system 10.

Through the design of the invention, since the color switch component is no longer required, the projection system 10 can tolerate higher light flux to enhance the display brightness. Also, the color wheel will not be affected by temperature variation.

Typically, an ultra high pressure mercury lamp is widely used in a projection system as a light source. However, such lamp has relatively low output in red light compared to the green and blue lights. In order to solve this problem, a typical method is to increase the duty cycle of the red light and decrease that of the green and blue lights during the control sequence for light valves to get a correct white balance. However, this may result in low visual brightness, for the visual brightness sensed by human eyes is mainly from the perception of the green light. Through the design of the invention, no matter what sections on the color wheel the light beam may pass through, the passed light beam will contain the red light (R) to automatically compensate the weaker red light output of the ultra high pressure mercury lamp. Thus, better visual brightness is achieved without the need of correcting the white balance.

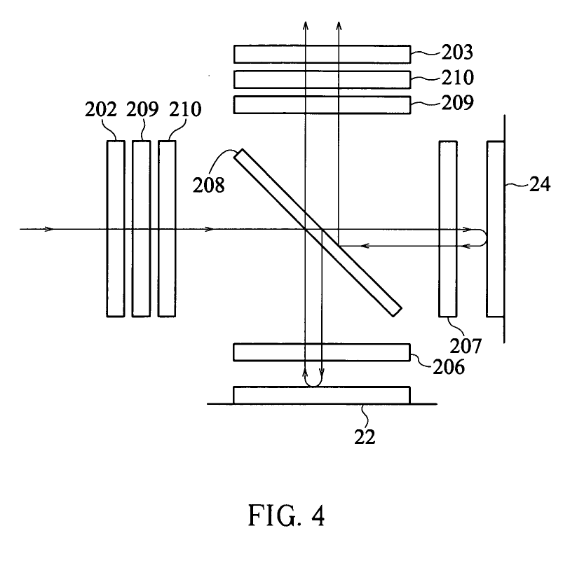

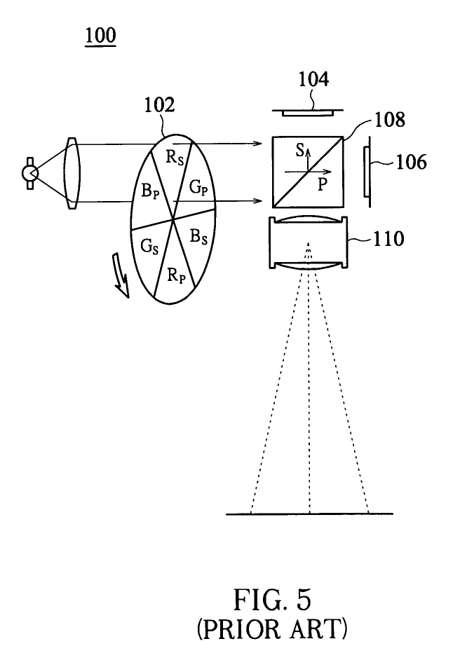

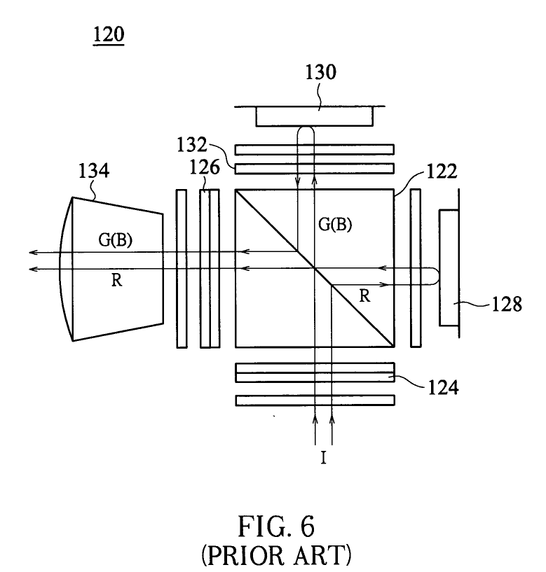

FIG. 4 shows another embodiment according to the invention. The color selector used in the invention only needs to achieve the effect of changing the polarization state of the red light, and thus its composition is not limited. Referring to FIG. 4, for instance, the light may sequentially pass through a Blue/Yellow color selector 209 and a Green/Magenta color selector 210 to achieve the same effect of changing the polarization light of the red light. In addition, the dichroic element only needs to pass light of one polarization state and reflect light of the other polarization state, and it is not limited to a polarized beam splitter cube. For example, a wire-grid polarizer 208 manufactured by Moxtek company may also be used, as in FIG. 4.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A color projection system, comprising:
a light source for generating a light beam having a first, second and third colored lights;
a color wheel segmented to form at least a first section for filtering out the second colored light and a second section for filtering out the third colored light, the first and second sections being alternately positioned in the traveling path of the light beam;
a polarization conversion device for polarizing the light beam;
a color separation device for receiving the light beam passed through the color wheel and the polarization conversion device, the color separation device comprising:
a dichroic element having a light input side, a first split-light side, a second split-light side, and a light output side, the light beam entering the dichroic element by the light input side and leaving the dichroic element by the light output side toward a projection lens;
a first color selector disposed adjacent to the light input side of the dichroic element; and
a second color selector disposed adjacent to the light output side of the dichroic element; and
a first and a second liquid crystal light valves positioned adjacent to the first and the second split-light sides, respectively.

2. The color projection system as recited in claim 1, wherein when the color wheel filters out the second colored light, the third colored light is incident onto the first liquid crystal light valve via the first split-light side of the dichroic element and the first colored light is incident onto the second liquid crystal light valve via the second split-light side.

3. The color projection system as recited in claim 1, wherein when the color wheel filters out the third colored light, the second colored light is incident onto the first liquid crystal light valve via the first split-light side of the dichroic element and the first colored light is incident onto the second liquid crystal light valve via the second split-light side.

4. The color projection system as recited in claim 1, further comprising an illumination optics disposed between the polarization conversion device and the color separation device.

5. The color projection system as recited in claim 4, wherein the illumination optics is a lens assembly.

6. The color projection system as recited in claim 1, wherein the color separation device further comprises:
a first polarizer positioned between the polarization conversion device and the first color selector; and
a second polarizer positioned between the second color selector and the projection lens.

7. The color projection system as recited in claim 1, wherein the color separation device further comprises:
a first quarter wave plate disposed between the dichroic element and the first liquid crystal light valve; and
a second quarter wave plate disposed between the dichroic element and the second liquid crystal light valve.

8. The color projection system as recited in claim 1, wherein the dichroic element is a polarized beam splitter cube or a wire-grid polarizer.

9. The color projection system as recited in claim 1, wherein the liquid crystal light valve is a reflective type liquid crystal on silicon (LCOS) panel.

10. The color projection system as recited in claim 1, wherein the color selector is a Red/Cyan color selector.

11. The color projection system as recited in claim 1, wherein the color selector is a combination of a Blue/Yellow color selector and a Green/Magenta color selector.

12. The color projection system as recited in claim 1, wherein the first section of the color wheel is a yellow section, and the second section of the color wheel is a magenta section.

13. The color projection system as recited in claim 1, wherein the color wheel further comprises a third section for transmitting white light.

14. A color projection system, comprising:
a light source for generating a light beam comprised of red, green and blue light;
a color wheel segmented to form at least a yellow section for filtering out the blue light and a magenta section for filtering out the green light, the yellow and magenta sections being alternately positioned in the traveling path of the light beam;
a polarization conversion device for transforming the light beam into a first polarization state;
a color separation device for receiving the light beam passed through the color wheel and the polarization conversion device, the color separation device comprising:
a dichroic element having a light input side, a first split-light side, a second split-light side and a light output side, the light beam entering the dichroic element by the light input side, and the red, green and blue lights separated from the light beam leaving the dichroic element by the light output side toward a projection lens;
a first color selector disposed adjacent to the light input side of the dichroic element for transforming the red light from the first polarization state to a second polarization state; and
a second color selector disposed adjacent to the light output side of the dichroic element for transforming the red light from the first polarization state to the second polarization state; and
a first and a second liquid crystal light valves positioned adjacent to the first and the second split-light sides, respectively.

15. The color projection system as recited in claim 14, wherein when the light beam passes through the yellow section, the green light with the first polarization state is incident onto the first liquid crystal light valve via the first split-light side of the dichroic element and the red light with the second polarization state is incident onto the second liquid crystal light valve via the second split-light side.

16. The color projection system as recited in claim 14, wherein when the light beam passes through the magenta section, the blue light with the first polarization state is incident onto the first liquid crystal light valve via the first split-light side of the dichroic element and the red light with the second polarization state is incident onto the second liquid crystal light valve via the second split-light side.

17. The color projection system as recited in claim 14, further comprising an illumination optics disposed between the polarization conversion device and the color separation device.

18. The color projection system as recited in claim 17, wherein the illumination optics is a lens assembly.

19. The color projection system as recited in claim 14, wherein the color separation device further comprises:
a first polarizer positioned between the polarization conversion device and the first color selector; and
a second polarizer positioned between the second color selector and the projection lens.

20. The color projection system as recited in claim 14, wherein the color separation device further comprises:
a first quarter wave plate disposed between the dichroic element and the first liquid crystal light valve; and
a second quarter wave plate disposed between the dichroic element and the second liquid crystal light valve.

21. The color projection system as recited in claim 14, wherein the dichroic element is a polarized beam splitter cube or a wire-grid polarizer.

22. The color projection system as recited in claim 14, wherein the liquid crystal light valve is a reflective type liquid crystal on silicon panel.

23. The color projection system as recited in claim 14, wherein the color selector is a Red/Cyan color selector.

24. The color projection system as recited in claim 14, wherein the color selector is a combination of a Blue/Yellow color selector and a Green/Magenta color selector.

25. The color projection system as recited in claim 14, wherein the color wheel further comprising a third section for transmitting white light.
